(19) United States
(12) Patent Application Publication
(10) Pub. No.: US 2003/0135629 A1
(43) Pub. Date: Jul. 17, 2003

(54) Advertising broadcast method and advertising broadcast device

(75) Inventors: Kazuo Sasaki, Kawasaki (JP); Ryuichi Matsukura, Kawasaki (JP); Hidenobu Ito, Kawasaki (JP); Hitoshi Yamauchi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/106,202

(22) Filed: Mar. 27, 2002

(30) Foreign Application Priority Data
Dec. 28, 2001 (JP) 2001-400676

(51) Int. Cl. G06F 15/16

(52) U.S. Cl. 709/229

(57) ABSTRACT

Advertising methods and devices for heightening network-based advertising effectiveness. (1) Advertiser terminal 4 that advertiser X operates transmits an advertising information and advertising request to ad-broadcasting device 5. (2) In response to a demand from user terminal 2a, ad-broadcasting device 5 transmits an advertiser list to user terminal 2a. (3) User terminal 2a transmits to ad-broadcasting device 5 a permit-change notice, which is a notice for advertiser X that permits change in user terminal 2a's status. (4) Ad-broadcasting device 5 transmits to buddy-list server 1 a status-update request for user terminal 2a. Advertiser X's advertising data is thereby transmitted to access-permitted terminals 2b, 2c for user terminal 2a. (5) Advertiser X's advertiser terminal 4 updates the advertising information. (6) Ad-broadcasting device 5, in accordance with the advertising-information update, transmits to buddy-list server 1 a request for an update on the status of user terminal 2a. Fresh advertising data from advertiser X is thereby transmitted to the access-permitted terminals 2b, 2c for user terminal 2a.

### BACKGROUND OF THE INVENTION

1. Technical Field

The present invention relates to technology for broadcasting advertisements utilizing a status-reporting system that via a network enables mutual accessing of status among users.

A “status-reporting system” as set forth in the present invention is composed of a number of user terminals and status-reporting servers connected via a network. The system acquires via the network information concerning user status and stores the status information correlatively with the users. A user terminal demanding desired user-status information is able to acquire it. As examples of status-information administration systems, location display systems, presence management systems and buddy list systems in place at corporate offices may be cited. With buddy list systems a user registers as buddies on a buddy list users whom he or she wants to access. The buddy list is administered by a status-reporting server. The user terminals acquire, and display on a list, status information on the user's buddies.

2. Description of Related Art

In recent years, communication through buddy list systems such as MSN® Messenger, AOL Instant Messenger^{SM}, and Yahoo® Messenger has been spreading rapidly on the Internet. With these systems, a user registers buddies on a buddy list, and then the buddies' status is reported to the user. “Buddy status” is for example connection-to-the-Internet status being “on,” “available,” “busy.” Furthermore, depending on the system, users may select the communication means, such as instant messaging or chat, according to buddy status.

Because the foregoing status-reporting systems ordinarily provide services to users at no charge, for the most part they are sustained by advertising fees through broadcast distribution of advertisements. Services that through advertising fees from banner ads on WWW (World Wide Web) sites enable Home Pages to be set up free of charge may be cited as an example of a form of service wherein the service is thus provided free of charge by means of advertising fees. Nevertheless, the banner ads on the site are not seen as long as users do not access the WWW site of their own accord. That is, banner ads are passive advertising as it were, and the number of users the ads reach seems to be small. Moreover, owing to the large time lag between when an advertiser updates a banner ad and when it is reflected on a Web page, advertisers cannot update their banner ads readily.

Meanwhile, in buddy list systems a display area for advertising is displayed on user terminals, and advertisements are also being output there. With buddy list systems, in which there are many users who constantly consult the status of their buddies, the time span during which advertising broadcast from status-reporting servers is displayed on user terminals is long. An advantage therefore is that advertising can be actively shown to users. Likewise, there is an advantage in that because advertising can be “pushed,” i.e., presented to the user without the user clicking on or otherwise actively seeking the ad information, from the status-reporting severs to user terminals, advertisers can readily update their ads.

While there are the above-described advantages to advertising broadcast-distribution systems utilizing buddy list systems, on the other hand they have problems such as the following, for example. That is, because ads unrelated to a user's tastes are displayed on the user's terminal, their advertising effectiveness will not be very high. Likewise, users harboring the feeling that they are being forced to look at ads in which they are not interested possibly will be seized by negative feelings.

An advertising method for solving these sorts of problems is proposed in Japanese Pat. App. H12-364371. By this method, a user registers as buddies advertisers that he or she would like to see, and then those advertisers' ads are reported to the user as status information on the advertisers. Advertising display with this method takes place in accordance with a user's tastes by the user making a clear indication in choice of advertiser. Still, no effects from advertising can be expected if a user does not register an advertiser as a buddy. That is, technology that heightens advertising effectiveness by casually showing advertising to users without straying far from the range of a user's interests has not been offered for status-reporting systems such as buddy lists.

### SUMMARY OF THE INVENTION

An object of the present invention is in advertising methods utilizing status-reporting systems to provide technology for broadcast-distribution of advertising that by being likely to be taken in by users is high in advertising effectiveness.

The invention in a first aspect is an advertising broadcast-distribution method, including: a connecting step of connecting to a status-reporting device that broadcasts user-terminal status information; a permission step of accepting designation of a user identifier identifying a user terminal, and designation of an advertiser identifier identifying an advertiser permitted to change information on the user terminal's status; an advertising-storing step of storing advertising information containing, in a single record, an advertiser's name, an advertiser identifier for the advertiser, advertising data by the advertiser, and the user identifier for the user terminal, being a broadcast-user terminal, that has granted change-permission to the advertiser; and a broadcast request step of having the status-reporting device execute broadcast of the advertising data to access-permitted terminals being user terminals that may access information on the broadcast-user terminal's status.

An instance in which a buddy list system is utilized as the status-reporting system will be explained. “User-terminal status information” includes information related to the status of the user terminal itself, and the status of the user who operates the user terminal. By this advertising method, user A broadcasts advertising data as his or her own status to users B, C, D . . . who are permitted to access his/her status. In particular, user A gives change-my-status permission to advertiser X. Advertiser X stores, as a broadcast user, user A from whom the change permission has been received. Advertiser X asks of the buddy list server that its advertising data be made a part of broadcast user A's status. The buddy list server broadcasts advertiser X's advertising data as user A's status to user A's access-permitted users B, C, D . . . . It should be noted that the advertising broadcast device that executes the advertising broadcast method may include the buddy list server, or may be connectable to the buddy list server via a network or the like.

A second aspect of the invention is the advertising broadcast method as set forth in the foregoing first aspect, but further including an advertising-recording step of accepting registration of the advertising data.

The invention in a third aspect is advertising broadcast method as set forth in the foregoing first aspect, while further including: an advertising update step of accepting an update for the advertising data; wherein the broadcast request step has the status-reporting device execute broadcast of the updated advertising data to the access-permitted terminals for the broadcast-user terminal for which the advertising data has been updated.

A fourth aspect is the advertising broadcast method set forth in the aforementioned first aspect, wherein the permission step and the advertising-storing step are iterated to generate a plurality of the records, and the permission step includes: an accepting step of accepting from the user terminal a demand for a listing of advertisers stored in the advertising-storing step; a list-transmission step of transmitting to the user terminal an advertiser list containing advertiser names stored by the advertising-storing step; and a designation-acceptance step of accepting from the user terminal at least one designation of an advertiser contained in the advertiser list; wherein the advertising-storing step stores the user terminal's user identifier as the broadcast-user terminal for the advertiser designated in the designation-acceptance step.

This method pertains to an example of a way in which a user grants change permission to an advertiser. An advertiser list is transmitted in accordance with a demand from a user terminal. Designation of an advertiser from among those in the transmitted advertiser list is accepted, and the user terminal is stored as a broadcast user for the designated advertiser.

In a fifth aspect, the invention is the advertising broadcast method set forth in the aforementioned first aspect, wherein the advertising-storing step stores advertising information further containing within the single record broadcast conditions for the advertising data.

A sixth aspect is the advertising broadcast method set forth in the foregoing fifth aspect, yet further including a user-information storing step of storing the user terminal's user identifier, and user information relating to the user terminal, as a single record; the permission step including: an acceptance step of accepting from the user terminal a demand for a listing of advertisers stored in the advertising-storing step; an extraction step of extracting advertising information whose broadcast conditions are satisfied by the user terminal's user information; a list transmission step of transmitting to the user terminal an advertiser list made up of the extracted advertising information; a designation-acceptance step of accepting from the user terminal designation of at least one advertiser contained in the advertiser list; wherein the advertising-storing step stores the user terminal's user identifier as a broadcast terminal for the advertiser designated in the designation-acceptance step.

When a demand for an advertiser list comes from a user terminal, based on user information for that user terminal, a list of those advertisers whose broadcast conditions are met by the user information is sent to the user terminal. Suppose, for example, that user A's access-permitted users are five persons. Suppose meanwhile that advertiser X's broadcast condition is “access-permitted user number not restricted,” and advertiser Y's broadcast condition is “access-permitted user number 10 or more.” In this case, advertiser X would be entered on the advertiser list, while advertiser Y would not be entered.

In a seventh aspect, the invention is the advertising broadcast method set forth in the aforementioned first aspect, while further including: a user-information recording step of recording user information containing, in a single record, the user identifier, status information on the user terminal specified by the user identifier, and access-permitted user identifiers for terminals that may access the status information; a status update step of accepting a latest-status report on, and updating the status information for, the user terminal recorded in the user-information recording step; and a status reporting step, if the user terminal's status information has been updated, of reporting the latest status information to the user terminal's access-permitted terminals; wherein the broadcast request step has broadcast of the advertising data executed by, in place of the status-reporting device, the status update step and the status reporting step.

The advertising device that executes this advertising method further has a buddy-list server function.

An eighth aspect is the advertising broadcast method set forth in the foregoing first aspect, and further including: a user-information recording step of recording user information containing, in a single record, the user identifier, and conduciveness-level data indicating a conduciveness level at which the user has contributed to the broadcasting of advertising data; and a conduciveness-level computation step of computing the conduciveness level based on the user information.

A conduciveness level at which a user has contributed to the broadcasting of advertising data is stored correlatively with the user. The conduciveness level may be computed as, for example, as cumulative cash-back points for a user terminal from an advertiser. Offering users awards that are based on the conduciveness level can be expected to serve as an incentive to users' granting change-permission to advertisers.

A ninth aspect of the invention is the advertising broadcast method as set forth in the foregoing first aspect, wherein: the advertising-storing step further stores, in the single advertising-information record, an advertising fee; and further including an advertising-fee computation step of computing the advertising fee.

A tenth aspect is the advertising broadcast method as set forth in the earlier-noted first aspect, while further including: a broadcast-results storing step of storing broadcast-result information indicating results of the broadcasting of the advertising data; and

broadcast-results transmission step of transmitting the broadcast-result information.

The broadcast-result information contains, e.g., a user identifier for the broadcast user, aggregate count of advertising-data broadcasts, and an e-mail address for the broadcast-user terminal. These items are transmitted to the advertiser terminal. The advertiser terminal for example determines, in accordance with the aggregate broadcast count, an award offered to the broadcast user, and using the e-mail address reports the award.

The invention in an eleventh aspect is an advertising program for making a computer function as: connecting means for connecting to a status-reporting device that broadcasts user-terminal status information; permission means for accepting designation of a user identifier identifying a user terminal, and designation of an advertiser identifier identifying an advertiser permitted to change information on the user terminal's status; advertising-storing means for storing advertising information containing, in a single record, an advertiser's name, an advertiser identifier for the advertiser, advertising data by the advertiser, and a user identifier for a broadcast-user terminal being a user terminal that has granted change-permission to the advertiser; and broadcast request means for having the status-reporting device execute broadcast of the advertising data to access-permitted terminals being user terminals that may access information on the broadcast-user terminal's status.

In a twelfth aspect, the present invention is a computer-readable recording medium on which is recorded an advertising program for executing: a connecting step of connecting to a status-reporting device that broadcasts user-terminal status information; a permission step of accepting designation of a user identifier identifying a user terminal, and designation of an advertiser identifier identifying an advertiser permitted to change information on the user terminal's status; an advertising-storing step of storing advertising information containing, in a single record, an advertiser's name, an advertiser identifier for the advertiser, advertising data by the advertiser, and a user identifier for a broadcast-user terminal being a user terminal that has granted change-permission to the advertiser; and a broadcast request step of having the status-reporting device execute broadcast of the advertising data to access-permitted terminals being user terminals that may access information on the broadcast-user terminal's status.

A thirteenth aspect of the invention is an advertising broadcast-distribution device furnished with: connecting means for connecting to a status-reporting device that broadcasts user-terminal status information; permission means for accepting designation of a user identifier identifying a user terminal, and designation of an advertiser identifier identifying an advertiser permitted to change information on the user terminal's status; advertising-storing means for storing advertising information containing, in a single record, an advertiser's name, an advertiser identifier for the advertiser, advertising data by the advertiser, and a user identifier for a broadcast-user terminal being a user terminal that has granted change-permission to the advertiser; and broadcast request means for having the status-reporting device execute broadcast of the advertising data to access-permitted terminals being user terminals that may access information on the broadcast-user terminal's status.

The present invention in a fourteenth aspect is an advertising request method including: a connecting step of connecting via a network to an advertising-broadcast device that executes the advertising broadcast-distribution method set forth in the foregoing first aspect; a recording step of accepting registration of advertising information on an advertiser; a request step of transmitting the advertising information and an advertising request to the advertising-broadcast device; an update step of accepting an update for the advertising information; and an update request step of transmitting updated advertising information to the advertising-broadcast device via the network.

A computer through which the aforementioned method is utilized is an advertiser terminal that an advertiser manages. The advertiser registers and updates advertising information utilizing an advertising request terminal.

In a fifteenth aspect, the invention is the advertising request method as set forth in the foregoing fourteenth aspect, and further including: a privileges storing step of storing privileges content offered to a broadcast-user terminal being a user terminal that has permitted status-information changes by the advertiser, of storing a user identifier identifying the broadcast-user terminal, and of storing combinations of the two; and a privileges update step of receiving from the advertising-broadcast device broadcast-result information indicating results of broadcasting the advertising information, and based on the broadcast-result information updating the privileges content

Privileges content that accords with broadcast results, e.g., aggregate broadcast count, and the broadcast-user terminal's user identifier are stored in the advertiser terminal. The privileges content is updates in accordance with the aggregate broadcast count, as is reported by means of electronic mail or the like.

A sixteenth aspect of the present invention is an advertising permission computer product for making a computer, having a status-reporting client, function on a status-reporting system, the advertising permission computer product for making the computer function as: status reporting means for reporting user status information, identifiers for access-permitted terminals being computers that may access the own status information, and/or identifiers for access-desiring terminals being computers that would like to access the status information; connection means for connecting via a network with an advertising-broadcast device that executes the method set forth in addendum 1; and permission reporting means for reporting to the advertising-broadcast device advertisers who are permitted to change the self-status information.

This computer product is utilized on a user terminal that is connectable to a status-reporting system. Utilizing this computer product enables the user terminal to make designations of advertisers whom it permits to change its status. Designating an advertiser results in advertising data being distributed, as the user terminal's status, to other user terminals that access its status.

In a seventeenth aspect, the present invention is a computer-readable recording medium on which is recorded an advertising permission program utilized in a computer having a status-reporting client on a status-reporting system, the computer-readable recording medium on which is recorded the advertising permission program for executing: a status reporting step of reporting user status information, identifiers for access-permitted terminals being computers that may access the own status information, and/or identifiers for access-desiring terminals being computers that would like to access the status information; a connection step of connecting via a network with an advertising-broadcast device that executes the method set forth in the foregoing first aspect; and a permission reporting step of reporting to the advertising-broadcast device advertisers who are permitted to change the self-status information.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a configuration of a buddy-list system that is an example of a status-reporting system;

FIG. 2 is an overall configuration of an advertising system having to do with a first embodiment example;

FIG. 3 is a conceptual explanatory diagram of an advertising method utilizing the advertising system in FIG. 2;

FIG. 4 is a block diagram illustrating the functional configuration of an ad-broadcasting device;

FIG. 5 is a conceptual explanatory diagram of advertising information set out in the first embodiment example;

FIG. 6 is an explanatory diagram illustrating flow of an advertising request process and a status change process set out in the first embodiment example;

FIG. 7 is an explanatory diagram illustrating flow of an advertising-information update process set out in the first embodiment example;

FIG. 8 is an overall configuration of an advertising system having to do with a second embodiment example, and a conceptual explanatory diagram of an advertising method utilizing the system configuration;

FIG. 9 is a block diagram illustrating the functional configuration of an ad-broadcasting terminal set out in the second embodiment example;

FIG. 10 is a conceptual explanatory diagram of advertising information set out in the second embodiment example;

FIG. 11 is a conceptual explanatory diagram of user information set out in the second embodiment example;

FIG. 12 is an explanatory diagram illustrating flow of an advertising request process and of a status change process set out in the second embodiment example;

FIG. 13 is an explanatory diagram illustrating flow of an advertising-information update process set out in the second embodiment example;

FIG. 14 is an overall configuration of an advertising system having to do with a third embodiment example, and a conceptual explanatory diagram of an advertising method utilizing the system configuration;

FIG. 15 is a block diagram illustrating the functional configuration of an ad-broadcasting terminal set out in the third embodiment example;

FIG. 16 is a conceptual explanatory diagram of user information set out in the third embodiment example;

FIG. 17 is a conceptual explanatory diagram of broadcast results information stored in a broadcast results table;

FIG. 18 is a conceptual explanatory diagram of information stored in a discount table;

FIG. 19 is an explanatory diagram illustrating flow of a status change process set out in the third embodiment example (1);

FIG. 20 is an explanatory diagram illustrating flow of a status change process set out in the third embodiment example (2);

FIG. 21 is an example of an advertising-request registration screen displayed by the advertiser terminal 4;

FIG. 22 is an example of an ad-data updating screen displayed by the advertiser terminal 4;

FIG. 23 is an example of a status-change permission screen display by the user terminals 2;

FIG. 24 is a display example of status information displayed on the user terminals 2, set out in the first embodiment example and the second embodiment example; and

FIG. 25 is a display example of status information, displayed on the user terminals 2, set out in the third embodiment example.

### DETAILED DESCRIPTION OF THE PREFERRED EMBODIMENTS

### EMBODIMENTS OF THE INVENTION

Buddy-List System

To begin with, the buddy list system will be initially explained. The buddy list system is an example of a status-reporting system that is utilized to execute the advertising method of the present invention.

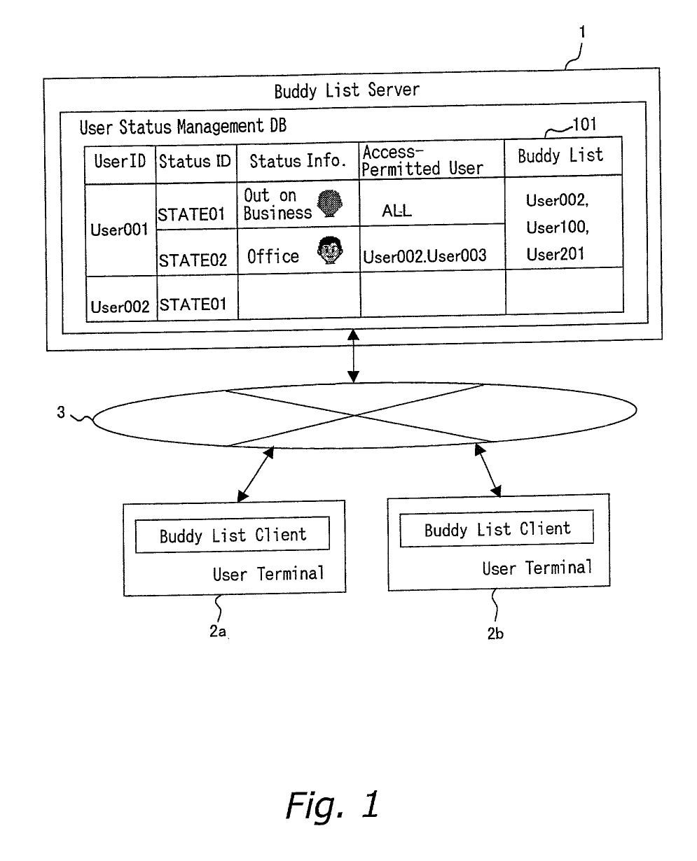

FIG. 1 illustrates the configuration of the buddy list system. The buddy list system is composed of a buddy list sever 1 by which user status alerts are managed, and a number of buddy list clients connected therewith via a network 3. The buddy list server 1 can be actualized utilizing a computer. The buddy clients are run on user terminals 2a, 2b, which are computers that users A and B operate.

User A, who operates user terminal 2a (User ID: User 001), registers, using his/her own buddy-list client, one or a number of items as his/her own status. A privacy level, e.g., “access-permitted user,” for the registered status information can be set with the buddy client per each status item. An “access-permitted user” herein is a user who is permitted to access status information on User 001 at user-terminal 2a. Likewise, user A registers on the buddy list server 1 a group of other users whose status information he or she would like to access. This user group is called a buddy list, and each of the users is called a buddy.

Meanwhile, the buddy list client updates status information on the user terminals that users B, C, D . . . , who are buddies, operate. The latest status information on buddies B, C, D . . . , which is updated while the buddy client is not launched, is acquired from the buddy list server 1 and displayed at the point the buddy client is launched.

The buddy list server 1 stores status information and access-permitted users reported from user terminal 2a correlatively with the user ID “User 001” in a user-status management database (DB) 101. The user-status management DB 101 is able to store a number of status items, identified by status IDs “state 01,” “state 02”. . . , for a single user ID. Further, the buddy list server 1 stores in the user-status management DB 101 the access-permitted users, and buddy-list content, reported from user terminal 2a. When the buddy list server 1 receives the latest status information on user A, it updates user A's status item, and then alerts user A's access-permitted users of the updated status information. It should be understood that the buddy list server 1 uniquely identifies each user terminal by the user IDs.

In short, in a buddy list system, a user registers as buddies users in whose status information he or she is interested. Status of the buddies is thereby generally displayed in a list on the user's terminal. Moreover, if the status information for the user's buddies has changed, the buddy status information displayed on the user's terminal is automatically updated. Connecting to a buddy list system and registering a buddy list enables a user readily to access the status of users about whom he or she is concerned.

### FIRST EMBODIMENT EXAMPLE

(1) Overview

(1-1) Outline of Overall Configuration and Advertising Processes

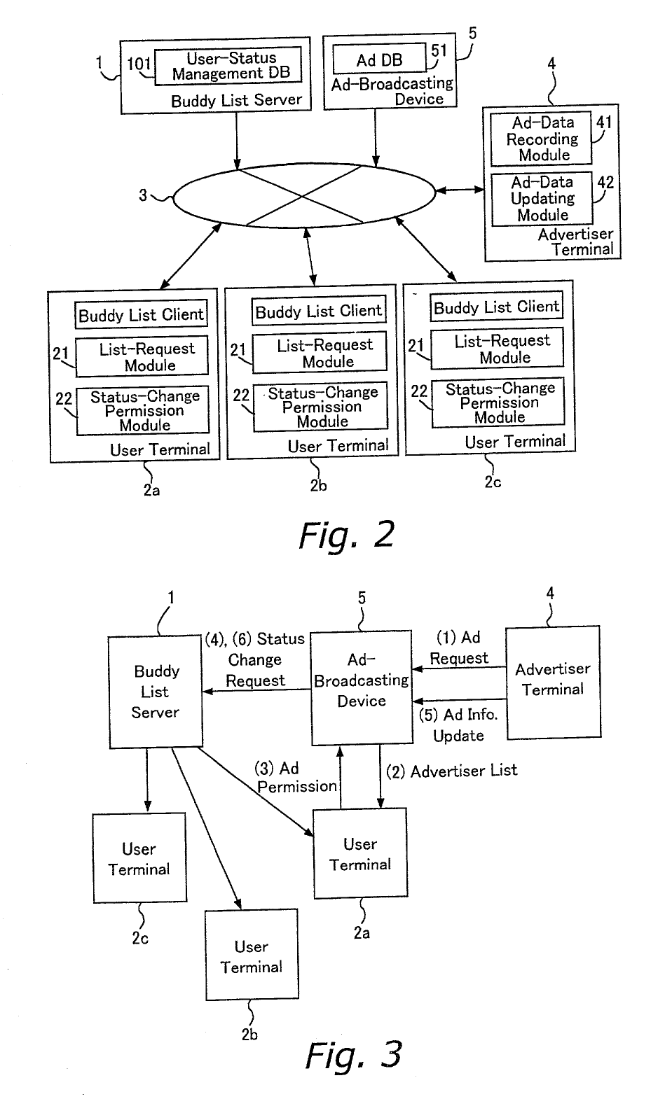

FIG. 2 is an overall configurational example of an advertising system to which an advertising method having to do with a first embodiment example of the present invention is applied. The buddy list server 1, user terminals 2a, 2b and 2c (referred to as “user terminals 2” hereinafter), an advertiser terminal 4, and an ad-broadcasting device 5, through their being connected to a network 3 such as the Internet, compose the advertising system.

The buddy list server 1 has functional modules identical with above-noted FIG. 1. Together with the buddy list server 1 the user terminals 2 on which the buddy-list clients are run compose the buddy list system. In addition to the buddy list clients, the user terminals 2 have a list-request module 21 and a status-change permission module 22.

The advertiser terminal 4 may be actualized utilizing a computer. The advertiser terminal 4 has an ad-data recording module 41 and an ad-data updating module 42. The ad-broadcasting device 5 has an ad DB 51 in which advertising information including ad data is stored per advertiser, as well as a number of modules. The configuration of the ad-broadcasting device 5 will be described later in detail.

FIG. 3 is a conceptual explanatory diagram of a way of advertising utilizing the advertising system illustrated in FIG. 2. This advertising method includes the following steps (1) through (6).

(1) Advertiser terminal 4 that advertiser X operates registers advertising information in the ad-broadcasting device 5, and transmits an advertising request to the ad-broadcasting device 5.

(2) In response to a demand from user terminal 2a, the ad-broadcasting device 5 transmits an advertiser list to user terminal 2a.

(3) User terminal 2a transmits to the ad-broadcasting device 5 a permit-change notice, which is a notice for advertiser X that permits change in user terminal 2a's status.

(4) Ad-broadcasting device 5 transmits to the buddy-list server 1 a status-update request for user terminal 2a. Advertiser X's advertising data is thereby transmitted to the access-permitted terminals 2b, 2c that user terminal 2a's access-permitted users operate.

(5) Advertiser X's advertiser terminal 4 updates the advertising information.

(6) Ad-broadcasting device 5, in accordance with the advertising-information update, transmits to the buddy-list server 1 a request for an update on the status of user terminal 2a. Fresh advertising data from advertiser X is thereby transmitted to the access-permitted terminals 2b, 2c for user terminal 2a.

(1-2) Configuration of and Ad DB for Advertising Broadcast Device

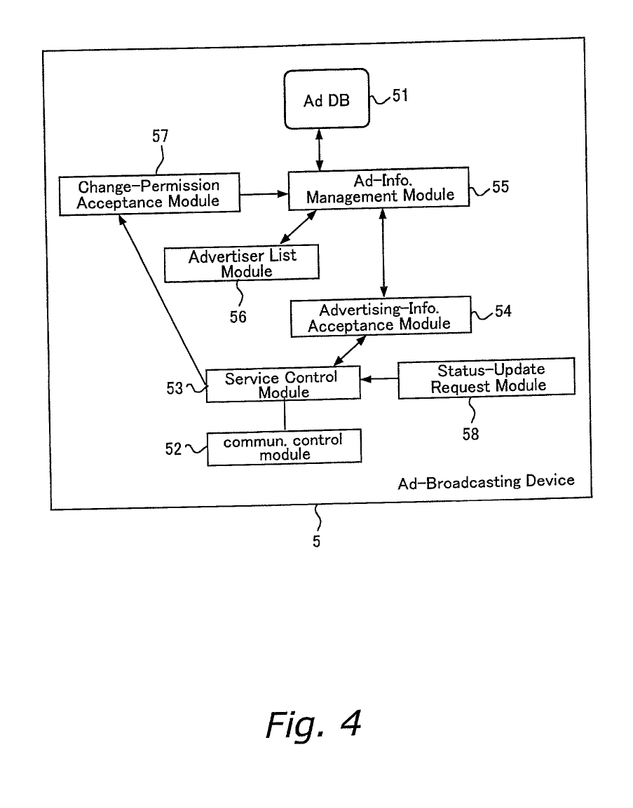

FIG. 4 is a block diagram illustrating a detailed functional configuration of the ad-broadcasting device 5. In addition to the ad DB 51, the ad-broadcasting device 5 has: a communications control module 52, a service control module 53, an advertising-information acceptance module 54, an advertising-information management module 55, an advertiser list module 56, a change-permission acceptance module 57, and a status-update request module 58.

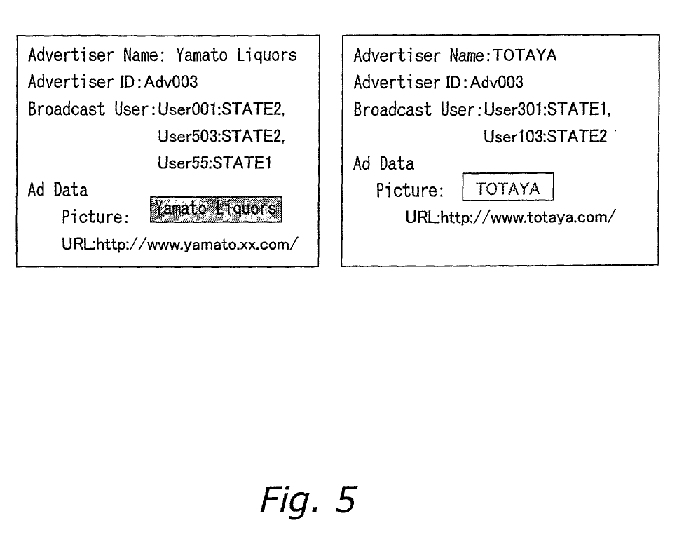

FIG. 5 is a conceptual explanatory diagram of advertising information stored in the ad DB 51. In the present embodiment example, the advertising information includes “Advertiser Name,” “Advertiser ID,” “Broadcast User,” and “Ad Data” in a single record. Theses advertising information items are registered in the ad-broadcasting device 5 through the advertiser terminal 4. Advertiser Name is for example a business designation or a store name. Advertiser ID is identifying data that the ad-broadcasting device 5 has uniquely assigned to each advertiser.

“Broadcast user” is the user ID of a user terminal whose own status the advertiser is permitted to change. If its own status includes a number of status items, IDs for status information that the broadcast user permits the advertiser to change and the broadcast user are combined and stored. The ad data is broadcast to the broadcast user's access-permitted terminals as status information on the broadcast user.

Ad data is any one or a combination of text data, image data, moving-picture data, audio data, or is addresses for the data. For example, ad data may be an image file displaying an advertiser's advertisement, and a URL that is the address of that image file.

(1-3) Process Flow

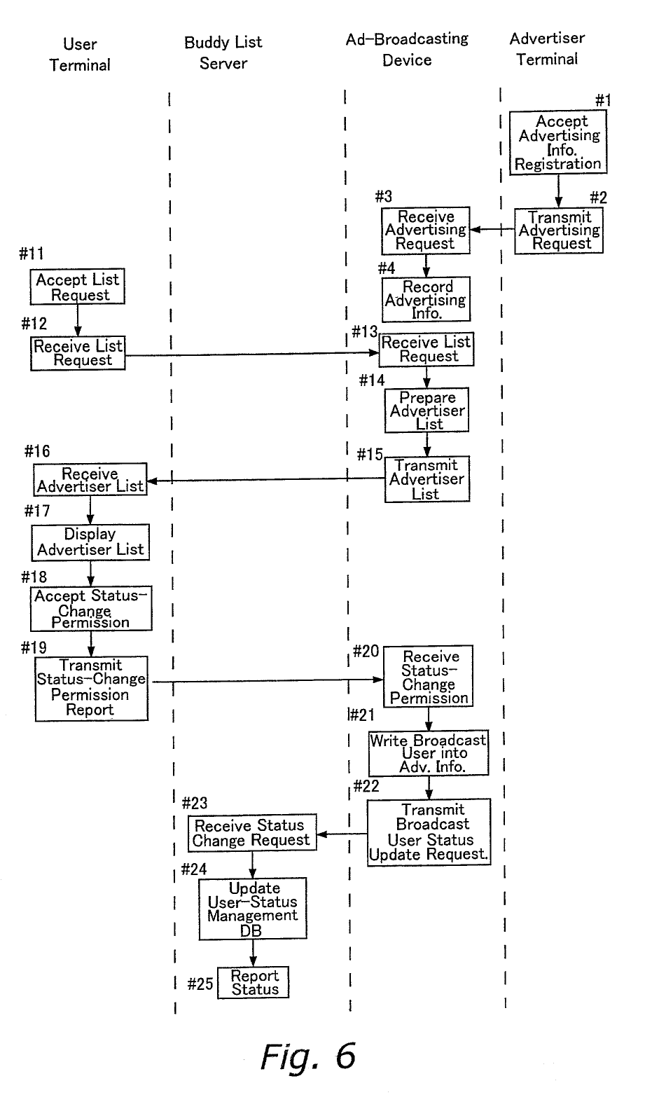

Next, functions of modules in the user terminals 2, the advertiser terminal 4 and the ad-broadcasting device 5 will be explained in detail while explaining the flow of processes in the advertising system under the present embodiment example. FIG. 6 is an explanatory diagram illustrating the flow of an advertising request process and a status change process that the advertising system carries out. These processes will be explained in turn.

Advertising Request Process

Ad-data recording module 41 on advertiser terminal 4 that advertiser X operates accepts registration of advertising information (#1), and transmits an advertising request to the ad-broadcasting device 5 (#2)—the advertising information being contained in the advertising request. The advertising-information acceptance module 54 in the ad-broadcasting device 5 receives the advertising request (#3), and the advertising-information management module 55 records the received advertising information in the ad DB 51 (#4). Here, precisely speaking, the advertising request is received by communications control module 52, and is allotted to the advertising-information acceptance module 54 by the service control module 53. The communications control module 52 carries out data transmission and reception between the ad-broadcasting device 5 and the other terminals. Likewise, the service control module 53 allots incoming data to the other modules according to type of incoming data, and passes data from the other modules sequentially to the communications control module 52.

Status Change Process

In the following, explanation is made taking user terminal 2a as an example, but the other user terminals have the same functions. The list-request module 21 in user terminal 2a accepts an acquisition request for an advertiser list in which are noted candidate advertisers to whom permission to change the user terminal 2a's status can be given (#11). Furthermore, list-request module 21 demands the advertiser list of the ad-broadcasting device 5 (#12). The advertiser list module 56 in the ad-broadcasting device 5 receives the just-noted demand (#13), and prepares an advertiser list in accordance with the demand (#14). The advertiser list module 56 transmits then the advertiser list to user terminal 2a (#15). The advertiser list contains a listing of advertiser names that are registered in the ad DB 51, and advertiser IDs.

The status-change permission module 22 in user terminal 2a displays the received advertiser list on a monitor or the like (#16, #17). The status-change permission module 22 accepts then the selection of any advertiser X from those displayed on the advertiser list (#18). Specifically, the status-change permission module 22 accepts grant of status-change permission to a selected advertiser X. This user terminal 2a becomes a “broadcast user” for advertiser X. At this time, the status-change permission module 22 may accept designation of which status information from among a number of status items is to be the ad data for advertiser X. An example is the designation of “state 02” from among status IDs “state 01” and “state 02.” Furthermore, status-change permission module 22 in user terminal 2a transmits a status-change permission notice to the ad-broadcasting device 5 (#19). The status-change permission notice contains the user's ID and the ID of the advertiser to whom the user has granted the status-change permission. Likewise, the status-change permission notice will at times contain a status ID.

When the change-permission acceptance module 57 in the ad-broadcasting device 5 receives the status-change permission notice (#20), it adds to the advertising information the user ID for the broadcast user and, the status ID if there is one (#21). Specifically, the change-permission acceptance module 57 writes the user ID “User 001” for user terminal 2a into the advertising information for the advertiser ID that is contained in the status-change permission notice. Subsequently, the status-update request module 58 in the ad-broadcasting device 5 transmits a status-update request for advertiser X's broadcast user User 001 to the buddy list server 1 (#22). The status-update request contains advertiser X's ad data, which is the fresh status information on user terminal 2a, user terminal 2a 's user ID User 001, and the status ID if there is one.

When it receives the status-update request, the buddy list server 1 updates the user status management DB 101 (#23, #24). Specifically, it writes the ad data as a fresh status into the status information for user ID “User 001.” If there is a status ID designation, the status information for the status ID is overwritten with the ad data. In addition, the buddy list server 1 broadcasts the user status, which is the ad data, to the access-permitted terminals for user ID “User 001” (#25). Because the ad data is broadcast as a part of user status based on individual personal interrelationships among the users, there should be few users repelled by receiving the ad data, and high gains in advertising effectiveness can be expected.

Advertising Information Update Process

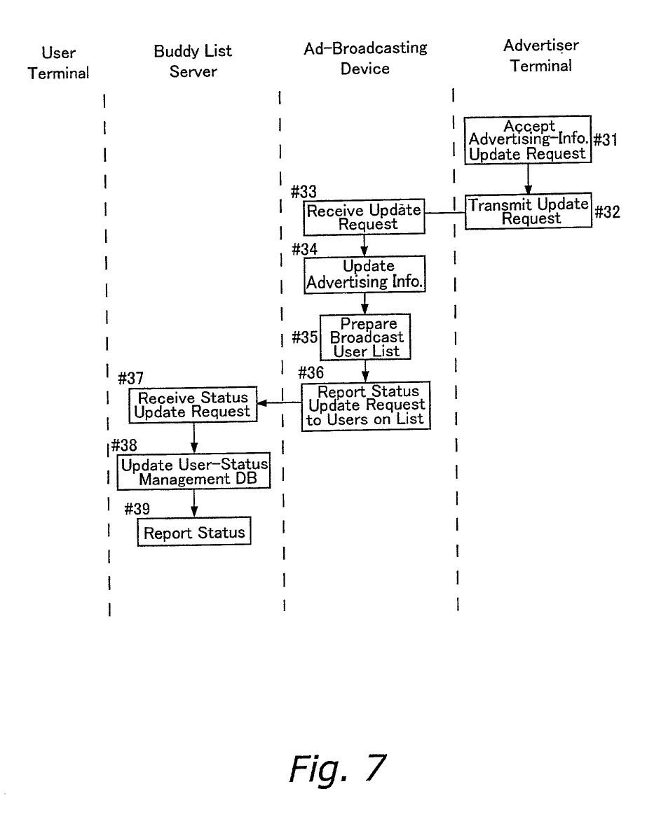

FIG. 7 is an explanatory diagram illustrating the flow of an advertising-information update process. The ad-data updating module 42 in the advertiser terminal 4 accepts an advertising-information update (#31). For instance, it accepts an update for image-data in the ad data, or an update of its URL. Herein, instances in which a portion of the image data in the ad data is updated are conceivable. Furthermore, the ad-data updating module 42 transmits an update request to the ad-broadcasting device 5 (#32). Advertiser ID and updated advertising information, e.g., new ad data, are contained in the update request.

The advertising-information acceptance module 54 in the ad-broadcasting device 5 receives the new ad data, and the advertising-information management module 55 records the ad data in the ad DB 51 (#33, #34). The advertising-information acceptance module 54 prepares then a broadcast-user list made up of advertiser X's broadcast users for whom the advertising information has been updated (#35). Subsequently, advertising-information acceptance module 54 transmits status update requests for each of the users in the broadcast-user list to the buddy list server 1 (#36). The update requests contain updated ad data, user IDs for the broadcast users, and status IDs for status information that the broadcast users permit changes in. It is to be noted that status IDs are not essential.

When it receives the status update requests (#37), the buddy list server 1 updates the user-status management DB 101 (#38). Specifically, the buddy list server 1 overwrites one of the broadcast users' status items with the fresh ad data. Likewise, the buddy list server 1 broadcasts the updated ad data to the broadcast user's access-permitted terminals (#39).

### SECOND EMBODIMENT EXAMPLE

(1) Overview

(1-1) Outline of Overall Configuration and Advertising Processes

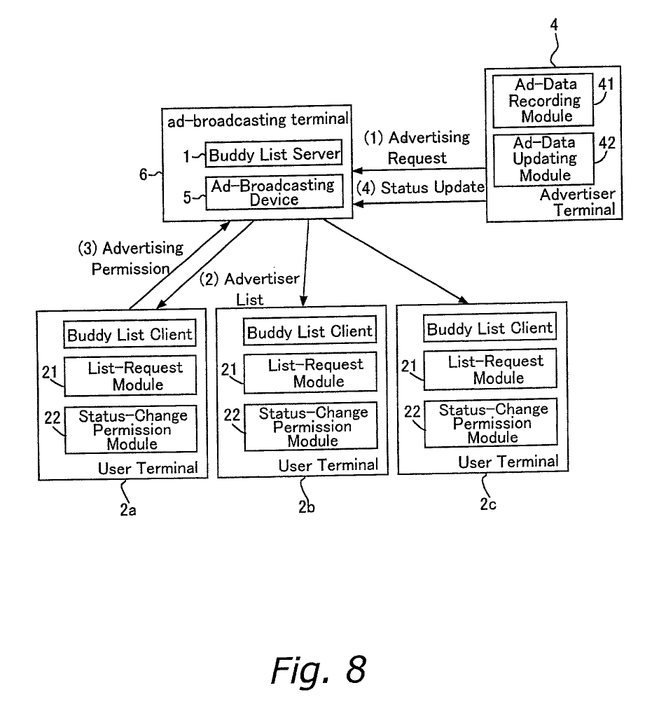

FIG. 8 is the overall configuration of an advertising system, and is a conceptual explanatory diagram of an advertising method, having to do with a second embodiment example.

The advertising system in the present embodiment example includes the user terminals 2a, 2b and 2c (referred to as “user terminals 2” hereinafter), the advertiser terminal 4, and an ad-broadcasting terminal 6. Elements in the figure having functions likewise as with the first embodiment example are indicated by labeling with like reference numerals. The user terminals 2, in addition to the buddy list clients, have a list-request module 21 and a status-change permission module 22. The advertiser terminal 4 has an ad-data recording module 41 and an ad-data updating module 42. The broadcast terminal 6 has the functions of the buddy list server 1 and the ad-broadcasting device 5. The configuration of the ad-broadcasting terminal 6 will later described in detail. The user terminals 2, the advertiser terminal 4, and the ad-broadcasting terminal 6 may be actualized utilizing computers.

An advertising method utilizing the advertising system illustrated in FIG. 8 includes the following steps (1) through (4).

(1) Advertiser terminal 4 that advertiser X operates registers advertising information in the ad-broadcasting terminal 6, and transmits an advertising request to the ad-broadcasting terminal 6.

(2) In response to a demand from user terminal 2a, the ad-broadcasting terminal 6 transmits an advertiser list to user terminal 2a.

(3) User terminal 2a transmits to the ad-broadcasting terminal 6 a permit-change notice, which is a notice for advertiser X that permits change in user terminal 2a's status. Advertiser X's advertising data is thereby transmitted to user terminal 2a's access-permitted terminals 2b, 2c.

(4) Advertiser X's advertiser terminal 4 updates the advertising information. Fresh advertising data from advertiser X is thereby transmitted to user terminal 2a's access-permitted terminals 2b, 2c.

(1-2) Configuration of Ad-Broadcasting Terminal and Database for Ad-Broadcasting Terminal

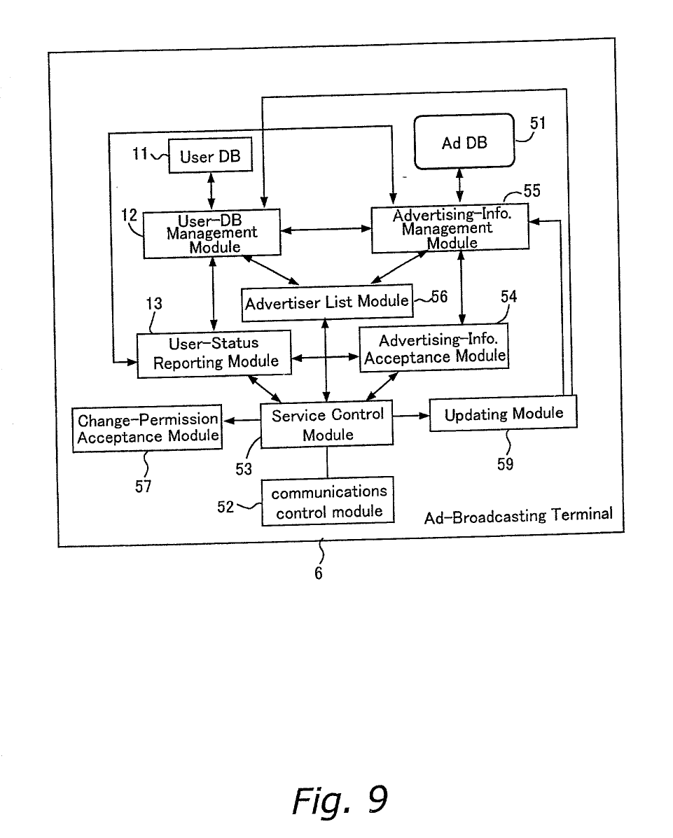

FIG. 9 is a block diagram illustrating the functional configuration of the ad-broadcasting terminal 6 set out in the advertising system of FIG. 8. The ad-broadcasting terminal 6, in order to unction as the ad-broadcasting device 5 in the first embodiment example, has: the ad DB 51, the communications control module 52, the service control module 53, the advertising-information acceptance module 54, the advertising-information management module 55, the advertiser list module 56, the change-permission acceptance module 57, and a performance-score updating module 59. Likewise, in order to function as the buddy list server 1, the ad-broadcasting terminal 6 has a user DB 11, a user-DB management module 12, and a user-status reporting module 13. Elements in the figure having functions likewise as in the foregoing buddy list system and as set out in the first embodiment example are indicated by labeling with like reference numerals.

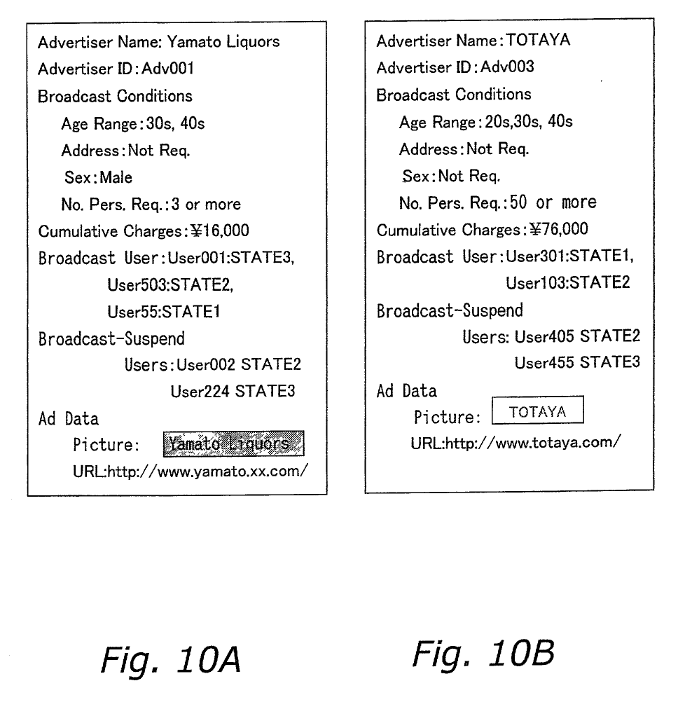

FIG. 10 is a conceptual explanatory diagram of advertising information stored in the ad DB 51. In the present embodiment example, the advertising information contains—in addition to “Advertiser Name,” “Advertiser ID,” “Broadcast User,” and “Ad Data”—“Broadcast Conditions,” “Cumulative Charges” and “Broadcast-Suspend User” in a single record. Advertiser Name, Advertiser ID, Broadcast User, and Ad Data are the same as in the foregoing first embodiment example.

“Broadcast Conditions” include conditions imposed on the broadcast user, and conditions imposed on the broadcast user's access-permitted users. Included in this example are “Age,” “Address,” “Sex,” and “No. Pers. Req.” Among these, Age Range, Address and Sex are conditions for the broadcast user's access-permitted users. In this example, a condition on the access-permitted users is that they are males in their 30's or 40's. Among the broadcast conditions the No. Pers. Req. is a condition imposed on the broadcast user. In this example, the condition is that the broadcast user's access-permitted users must be three or more persons. Broadcasting of ad data that satisfies the broadcast conditions may be expected to raise advertising effectiveness.

“Cumulative Charges” are advertising fees imposed on the advertiser. Each advertiser pays the advertising fees to the administrator of the ad-broadcasting terminal 6, for example. The cumulative-charges billing total is computed based on ad data size, broadcast user's access-permitted user count, length of time that each access-permitted user is registered as an access-permitted user, and number of times ad data is registered. Advertising fees collected from the advertisers might be for the cost of running the advertising service, and for the profit of service providers.

A “Broadcast-Suspend User” means a user who, having once granted status-change permission to an advertiser, thereafter has suspended.

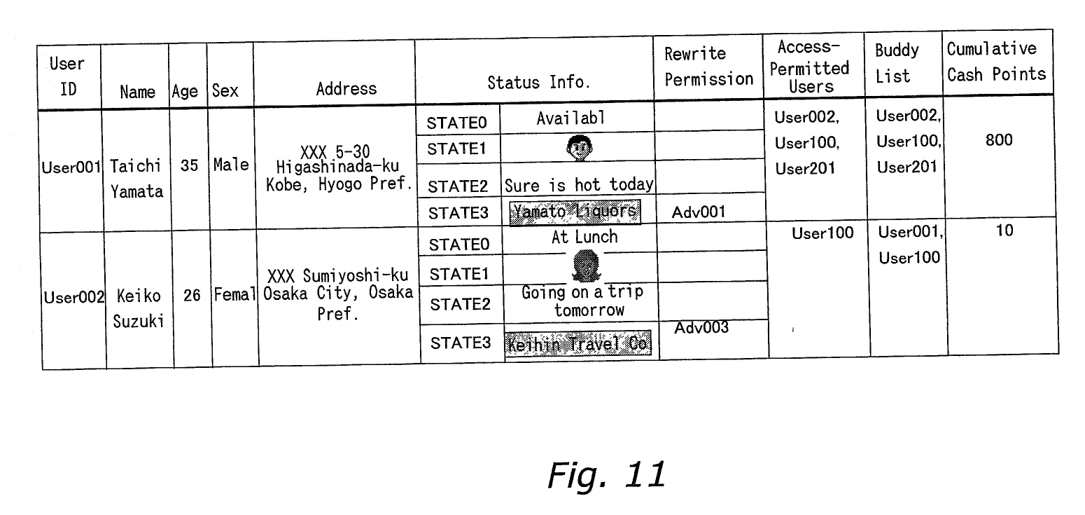

FIG. 11 is a conceptual explanatory diagram of user information stored in the use DB 11. In addition to the basic information stored in the user-status management DB 101 illustrated in FIG. 1, “Personal Information,” “Change-Permission ID,” and “Cumulative Cash Points” are further annexed to the user information. Name, years of age, sex, and address are illustrated as examples of Personal Information. In addition to these items, e.g., e-mail address and occupation may also be included in the personal information. The broadcast conditions Age Range, Address and Sex are judged based on the personal information.

“Change-Permission ID” is an ID for an advertiser to whom a user has granted status-change permission, and corresponds to a status ID for status information on which status-change permission is granted. “Cumulative Cash Points” are awarded to a broadcast user based on the user's performance score broadcasting ad data. For example, based on the value of the cumulative cash points the advertiser offers the user discounts on products and services. The cumulative cash points are computed based on access-permitted user count, length of time that access-permitted users are registered as access-permitted users, and number of times ad data is broadcast.

(1-3) Process Flow

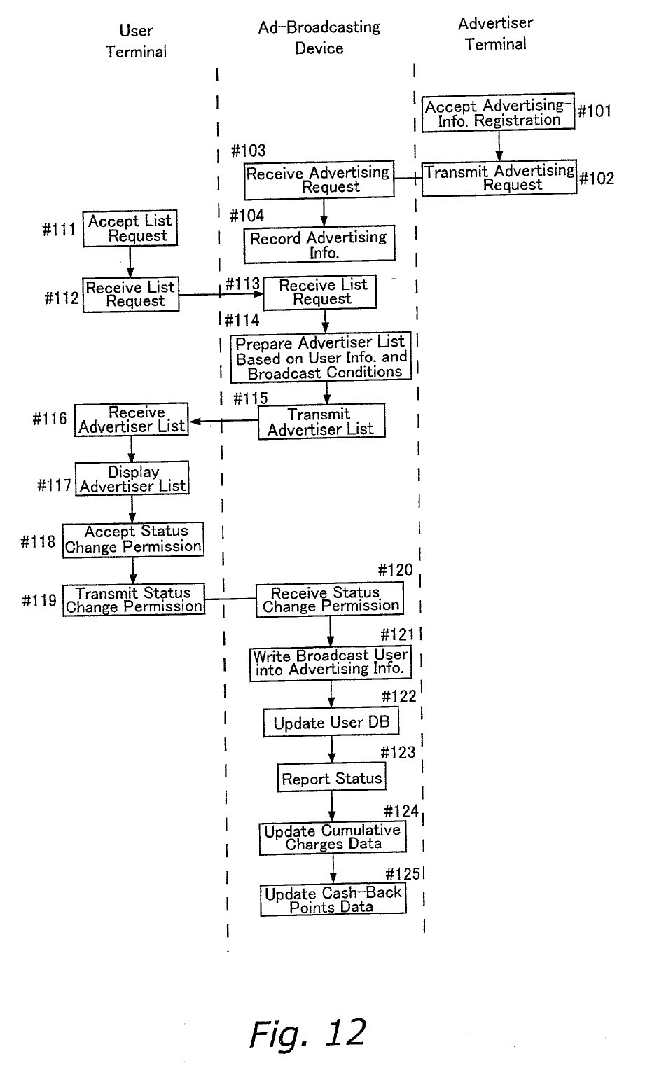

Next, functions of modules in the user terminals 2, the advertiser terminal 4 and the ad-broadcasting terminal 6 will be explained in detail while explaining the flow of processes in the advertising system under the present embodiment example. FIG. 12 is an explanatory diagram illustrating the flow of an advertising request process and a status change process that the advertising system carries out. These processes will be explained in turn.

Advertising Request Process

The flow of the advertising request process is the same as set out in the first embodiment example. That is, ad-data recording module 41 on advertiser terminal 4 that advertiser X operates accepts registration of advertising information (#101), and transmits an advertising request to the ad-broadcasting terminal 6—the advertising information being contained in the advertising request. The advertising-information acceptance module 54 in the ad-broadcasting terminal 6 receives the advertising request (#103), and the advertising-information management module 55 records the received advertising information in the ad DB 51 (#104). Here, precisely speaking, the advertising request is received by communications control module 52, and is allotted to the advertising-information acceptance module 54 by the service control module 53. Likewise as with the first embodiment, the communications control module 52 carries out data transmission and reception between the ad-broadcasting terminal 6 and the other terminals. Further, the service control module 53 allots incoming data to the other modules according to type of incoming data, and passes data from the other modules sequentially to the communications control module 52.

Status Change Process

In the following, explanation is made taking user terminal 2a as an example, but the other user terminals have the same functions. Furthermore, the advertising information and user information is assumed to be in the state shown in the foregoing FIGS. 10 and 11.

The list-request module 21 in user terminal 2a accepts a request for an advertiser list, and demands the advertiser list of the ad-broadcasting terminal 6 (#111, #112). The advertiser list module 56 in the ad-broadcasting terminal 6 prepares an advertiser list in accordance with the demand, and transmits the advertiser list to user terminal 2a (#113, #114, #115). Herein, the advertiser list module 56 prepares the advertiser list based on the broadcast conditions in the advertising information, and on the user information. Advertisers singled out by the advertiser list are advertisers for whom user terminal 2a satisfies the number-of-persons requirement among the broadcast conditions, and for whom any of user terminal 2a's access-permitted users satisfy the other broadcast conditions.

The status-change permission module 22 in user terminal 2a accepts status-change permission with respect to any of the advertisers displayed on the received advertiser list, and transmits a status-change permission notice to the ad-broadcasting terminal 6 (#116 through #119). The status-change permission module 22 may accept designation of which status information from among a number of status items is to be the ad data for advertiser X. The status-change permission notice contains the user ID and the ID of the advertiser to whom the user has granted the status-change permission. Likewise, the status-change permission notice will at times contain a status ID.

Based on the status-change permission notice, the change-permission acceptance module 57 in the ad-broadcasting terminal 6 records the user ID and the status ID, if there is one, in the ad DB 51 (#120, #121). The change-permission acceptance module 57 also transmits the status change request containing the broadcast user ID, the status ID and the ad data to the user-status reporting module 13. Receiving the request just noted, the user-DB management module 12 adds the ad data to the status information for user terminal 2a (User ID: User 001) (#122). If a status ID has been designated, a status item for the designated status ID becomes the ad data. The user-status reporting module 13 reports the fresh user status to user terminal 2a's access-permitted terminals (#123).

The performance-score updating module 59 in the ad-broadcasting terminal 6 updates the cumulative charges data for the advertising information that includes the broadcast ad data (#124). The cumulative charges data may be given, for example, as: cumulative charges data=(image-file size in ad data)×(number of user terminal 2a's access-permitted terminals). Likewise, the performance-score updating module 59 updates the cumulative cash points in user terminal 2a's user information (#125). To give an example, the cumulative cash points are found as the sum total: (user terminal 2a's access-permitted user count×length of time user terminal 2a user is registered as a broadcast user).

Advertising Information Update Process

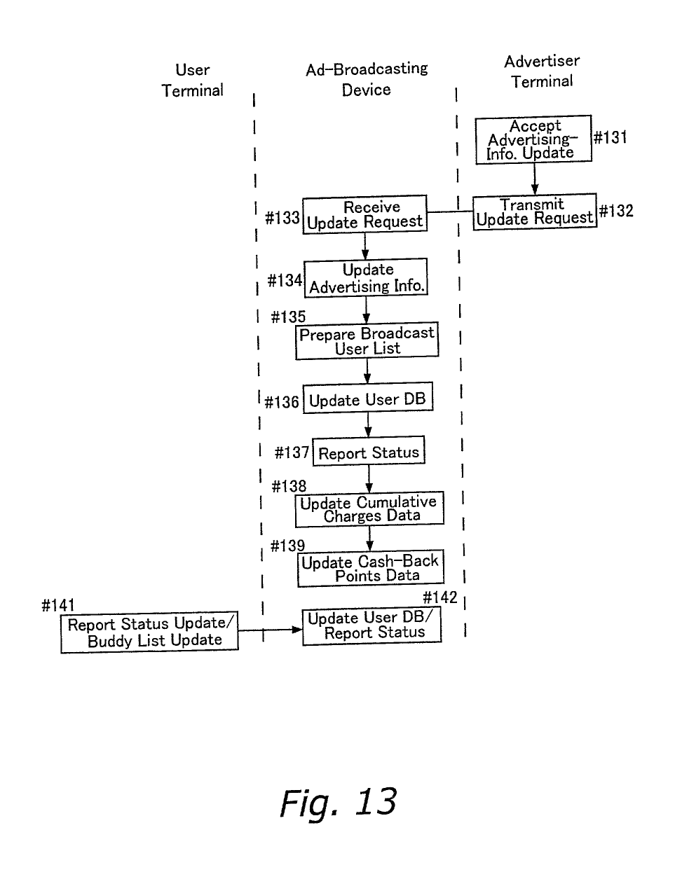

FIG. 13 is an explanatory diagram illustrating the flow of an advertising-information update process that the advertising system carries out. The advertiser terminal 4, by means of the ad-data updating module 42, accepts an advertising-information update and transmits an update request to the ad-broadcasting terminal 6 (#131, #132). When it receives the update request, the advertising-information acceptance module 54 in the ad-broadcasting terminal 6 updates the advertising information that corresponds to the advertiser ID contained therein (#133, #134). The advertising-information acceptance module 54 prepares then a broadcast user list (#135). Subsequently, the user-DB management module 12 updates the user DB 11 (#136). That is, one of the status items for the user IDs contained in the broadcast user list is updated into fresh ad data. The user-status reporting module 13 transmits the updated ad data as the broadcast user's user status to the broadcast user's access-permitted terminals (#137). Thereafter the performance-score updating module 59 updates the cumulative charges data, and updates the cumulative cash point data, in the same manner as described earlier (#138, #139).

It should be understood that in the advertising system having to do with the present embodiment, the ad-broadcasting terminal 6 functions also as the buddy list server 1. Specifically, the user-status reporting module 13 accepts from the user terminals 2 update reports on status information, and update reports on access-permitted users and buddy lists (#141). The user-DB management module 12 records the reported information in the user DB 11 (#142).

### THIRD EMBODIMENT EXAMPLE

(1) Overview

(1-1) Outline of Overall Configuration and Advertising Processes

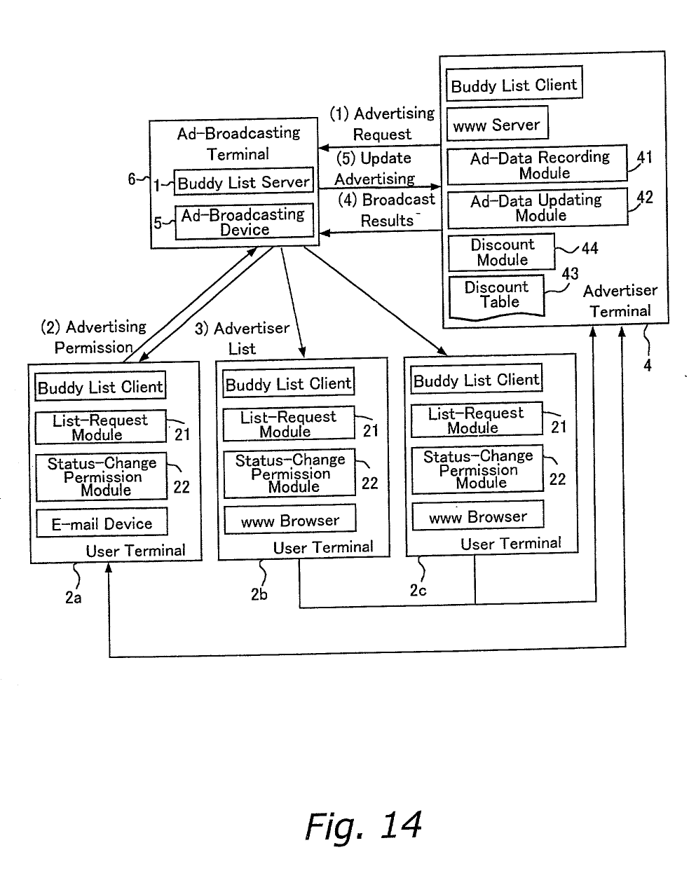

FIG. 14 is the overall configuration of an advertising system, and is a conceptual explanatory diagram of an advertising method utilizing the system, having to do with a second embodiment example. The advertising system in the present embodiment example includes the user terminals 2a, 2b and 2c (referred to as “user terminals 2” hereinafter), the advertiser terminal 4, and an ad-broadcasting terminal 6. Elements in the figure having functions likewise as with the first embodiment example are indicated by labeling with like reference numerals. The user terminals 2, in addition to the buddy list clients, have a list-request module 21 and a status-change permission module 22. Further, the user terminals 2 have an e-mail device as one example of a means for receiving notices from the advertiser terminal 4, and a WWW browser as one example of a means for purchasing products from advertisers.

The advertiser terminal 4 has the ad-data recording module 41, the ad-data updating module 42, a discounting module 44 and a discount table 43. The advertiser terminal 4 also has an e-mail device as one example of a means for transmitting notices to the user terminals 2, and a WWW server as one example of a means for marketing products. The broadcast terminal 6 has the functions of the buddy list server 1 and the ad-broadcasting device 5. The configuration of the ad-broadcasting terminal 6 will later described in detail. The user terminals 2, the advertiser terminal 4, and the ad-broadcasting terminal 6 may be actualized utilizing computers.

An advertising method utilizing the advertising system illustrated in FIG. 14 includes the following steps (1) through (5).

(1) Advertiser terminal 4 that advertiser X operates registers advertising information in the ad-broadcasting terminal 6, and transmits an advertising request to the ad-broadcasting terminal 6.

(2) In response to a demand from user terminal 2a, the ad-broadcasting terminal 6 transmits an advertiser list to user terminal 2a.

(3) User terminal 2a transmits to the ad-broadcasting terminal 6 a permit-change notice, which is a notice for advertiser X that permits change in user terminal 2a's status. Advertiser X's advertising data is thereby transmitted to user terminal 2a's access-permitted terminals 2b, 2c.

(4) The ad-broadcasting terminal 6 reports ad-data broadcast results to the advertiser terminal 4. In accordance with the broadcast user's broadcast performance score, the advertiser offers a discount or like award. By notifying the broadcast user of this award for example, the broadcast user does online shopping utilizing a discount ID reported from the advertiser

(5) Advertiser X's advertiser terminal 4 updates the advertising information. Fresh advertising data from advertiser X is thereby transmitted to user terminal 2a's access-permitted terminals 2b, 2c.

(1-2) Configuration of Ad-Broadcasting Terminal and Database for Ad-Broadcasting Terminal and Advertiser Terminal

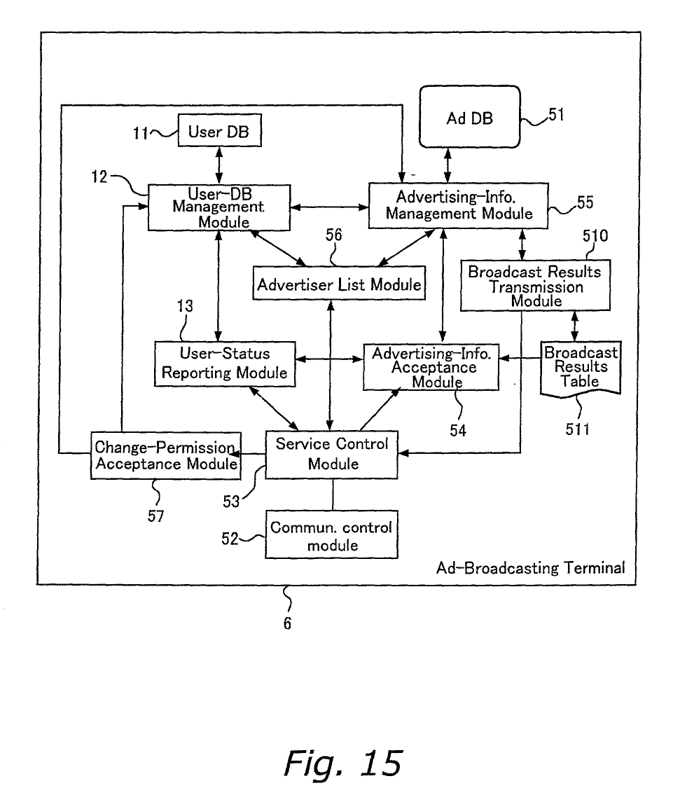

FIG. 15 is a block diagram illustrating the functional configuration of the ad-broadcasting terminal 6.

The ad-broadcasting terminal 6, in order to function as the ad-broadcasting device 5 in the first embodiment example, has: the ad DB 51, the communications control module 52, the service control module 53, the advertising-information acceptance module 54, the advertising-information management module 55, the advertiser list module 56, the change-permission acceptance module 57, a broadcast-results transmission module 510, and a broadcast results table 511. Likewise, in order to function as the buddy list server 1, the ad-broadcasting terminal 6 has a user DB 11, a user-DB management module 12, and a user-status reporting module 13. Elements in the figure having functions likewise as in the foregoing buddy list system and as set out in the first embodiment example and second embodiment example are indicated by labeling with like reference numerals. The advertising information in the ad DB 51 is likewise as with FIG. 10 mentioned earlier.

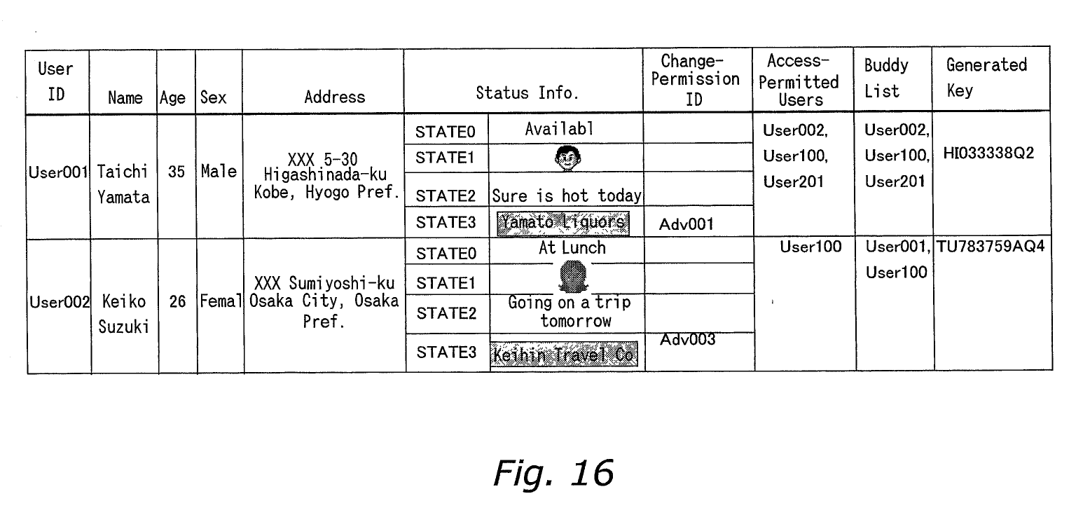

FIG. 16 is a conceptual explanatory diagram of user information stored in the DB 11 for the ad-broadcasting terminal 6. In addition to the basic information stored in the user-status management DB 101 illustrated in FIG. 1, the user information includes “Personal Information,” “Change-Permission ID,” and “Generated Key.” The Personal Information and Change-Permission ID are likewise as with the foregoing second embodiment example. The Generated Key is reported to the access-permitted terminals as a part of the broadcast user's status information.

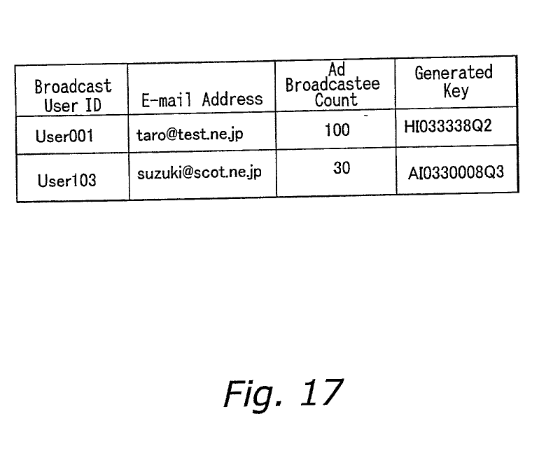

FIG. 17 is a conceptual explanatory diagram of broadcast results information stored in the broadcast results table 511 in the ad-broadcasting terminal 6. Herein, the Broadcast User ID, which is the broadcast user's user ID, the broadcast user's E-mail Address, Ad Broadcastee Count and Generated Key are stored as a single record in the broadcast results information. The broadcast user's e-mail address is acquirable for example from the personal information in the user DB 11, illustrated in FIG. 11. The Ad Broadcastee Count is one example of data that indicates the broadcast user's broadcast performance score. Herein, the Ad Broadcastee Count is the aggregate count of access-permitted terminals to which ad data from the broadcast user specified by the broadcast user ID was broadcast. If the Ad Broadcastee Count is reported to the advertiser terminal 4, based on the Ad Broadcastee Count the advertising terminal 4 may compute discount rates per broadcast user. The Generated Key is an arbitrary row of characters produced for example by stringing together letters and numbers at random. Likewise, the Generated Key is written into the broadcast user's record, and broadcast together with the ad data to the broadcast user's access-permitted terminals. For example, an access-permitted user may receive a discount from the advertiser when to purchase a product he or she inputs the Generated Key and the broadcast user's ID.

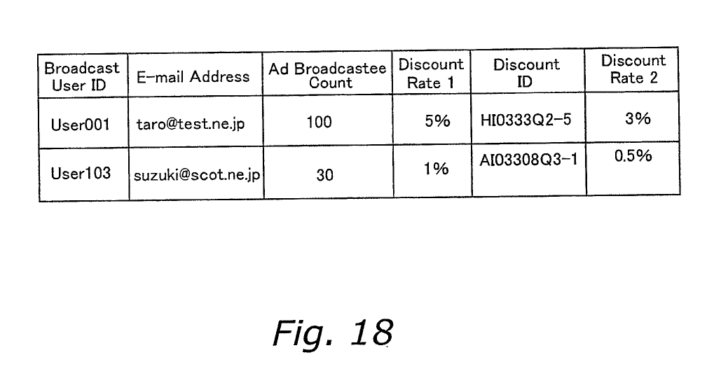

FIG. 18 is a conceptual explanatory diagram of the discount table in the advertiser terminal 4. “Broadcast User ID,” “E-mail Address,” “Ad Broadcastee Count,” “Discount Rate 1,” “Discount ID” and “Discount Rate 2” are stored in a single record in the discount table 43. The Broadcast User ID, E-mail Address and Ad Broadcastee Count are reported from the ad-broadcasting terminal 6 to the advertiser terminal 4. Discount Rate 1 is a discount rate that the advertiser terminal 4 sets for the broadcast user. Discount ID is identifying information indicating the discount rate 1. For example, the advertiser terminal 4 transmits to the broadcast user's e-mail address the Discount ID corresponding to Discount Rate 1. By purchasing a product using the Discount ID, the broadcast user may receive a discount on the product. Discount Rate 2 is a discount rate that the advertiser terminal 4 sets with respect to the access-permitted users for the broadcast user ID.

(1-3) Process Flow

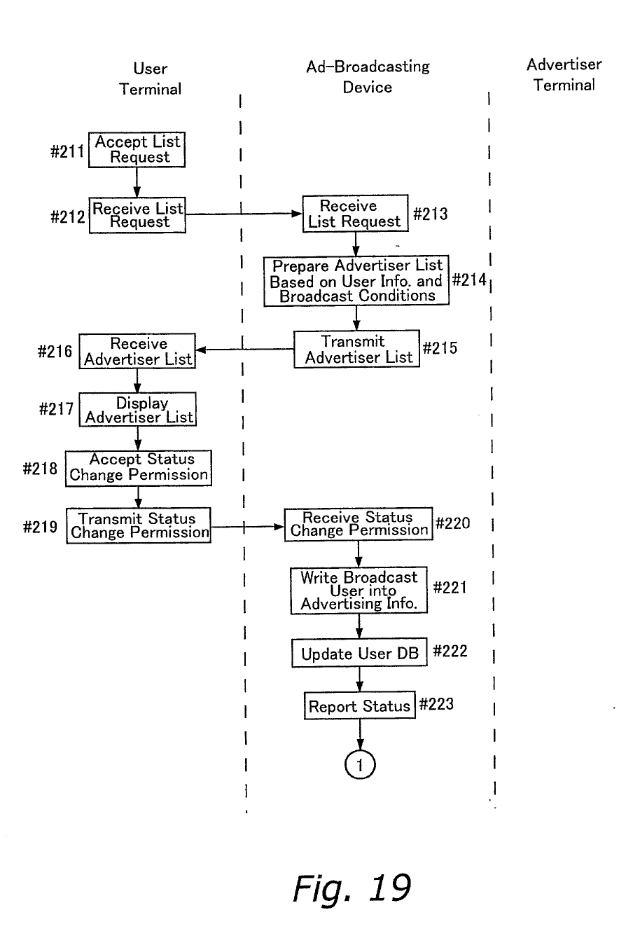

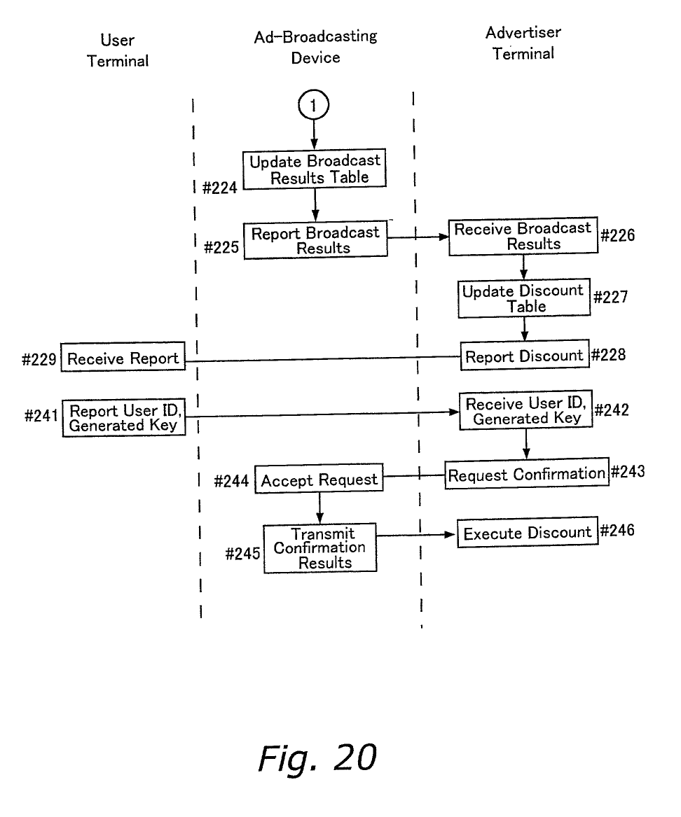

Next, functions of modules in the user terminals 2, the advertiser terminal 4 and the ad-broadcasting terminal 6 will be explained in detail while explaining the flow of processes in the advertising system under the present embodiment example. FIGS. 19 and 20 are an explanatory diagram illustrating the flow of a status change process that the advertising system carries out. Here, the flow of the advertising request process and of the advertising-information update process are likewise as with FIGS. 12 and 13 for the foregoing second embodiment example.

Status Change Process

In the following, explanation is made taking user terminal 2a as an example, but the other user terminals have the same functions. Furthermore, the advertising information and user information is assumed to be in the state shown in the foregoing FIGS. 10 and 16.

The list-request module 21 in user terminal 2a accepts a request for an advertiser list, and demands the advertiser list of the ad-broadcasting terminal 6 (#211, #212). The advertiser list module 56 in the ad-broadcasting terminal 6 prepares an advertiser list in accordance with the demand, and transmits the advertiser list to user terminal 2a (#213, #214, #215). Herein, advertisers singled out by the advertiser list are advertisers for whom user terminal 2a satisfies the number-of-persons requirement among the broadcast conditions, and for whom any of user terminal 2a's access-permitted users satisfy the other broadcast conditions.

The status-change permission module 22 in user terminal 2a accepts status-change permission with respect to any of the advertisers displayed on the received advertiser list, and transmits a status-change permission notice to the ad-broadcasting terminal 6 (#216 through #219). The status-change permission module 22 may accept designation of which status information from among a number of status items is to be the ad data Or advertiser X. The status-change permission notice contains the user ID and the ID of the advertiser to whom the user has granted the status-change permission.

Based on the status-change permission notice, the change-permission acceptance module 57 in the ad-broadcasting terminal 6 records the user ID and the status ID, if there is one, in the ad DB 51 (#220, #221). The change-permission acceptance module 57 also transmits the status change request containing the broadcast user ID, the status ID and the ad data to the user-status reporting module 13. Receiving the request just noted, the user-DB management module 12 adds the ad data to the status information for user terminal 2a (User ID: User 001) (#222). If a status ID has been designated, a status item for the designated status ID becomes the ad data. The user-status reporting module 13 reports the fresh user status to user terminal 2a's access-permitted terminals (#223).

The broadcast-results transmission module 510 in the ad-broadcasting terminal 6 updates the broadcast results table 511 (#224). First, the broadcast-results transmission module 510 retrieves from the broadcast results table 511 the record containing the user ID “User 001” for the broadcast user who has transmitted ad data as his or her status. It then sums to ad broadcastee count in this record the number of access-permitted users for user terminal 2a (User ID: User 001) at the current point in time.

The broadcast-results transmission module 510 transmits the updated broadcast results information to the advertiser terminal 4 (#225). The discounting module 44 in the advertiser terminal 4 receives the broadcast results information (#226) and updates the discount table 43 (#227). Specifically, the discounting module 44 searches the discount table 43 with the user ID contained in the reported broadcast results information as a key, and updates the ad broadcastee count for the applicable record. It likewise, based on the updated ad broadcastee count, updates Discount Rate 1 and Discount Rate 2. The broadcast-results transmission module 510 may notify the broadcast user's user terminal 2a of the updated results (#229). This discount report may be made, e.g., by transmission to the e-mail address written in the Discount ID. A broadcast user permitting an advertiser to change the broadcast user's status may purchase products and services from the advertiser using the reported discount ID. Purchase of products using the discount ID may be done for example through an advertiser's on-line shopping site that the WWW server for the advertiser terminal 4 sets up. Offering of discounts and like awards from the advertiser to the user may be expected to function as an incentive to granting status-change permission.

Awards such as discounts may be granted not only to the broadcast user, but also to the broadcast user's access-permitted users. Having it so that not only ad data, but also Generated Keys and the broadcast user ID (User 001) are reported to the broadcast user's (User ID: User 001) access-permitted user terminals 2b, 2c . . . (User ID: User 002, User 100, User 201) is an example. Utilizing the Generated Key and the broadcast user ID, the access-permitted user terminals 2b, 2c . . . transmit a procurement demand to the advertiser terminal 4 (#241). This demand is made for example by accessing, through WWW browsers on the access-permitted user terminals 2b, 2c . . . , an advertiser's on-line shopping site that the WWW server on the advertiser terminal 4 sets up. The discounting module 44 in the advertiser terminal 4 transmits a request for confirming the user ID and Generated Key that have been sent in (#243). The broadcast-results transmission module 510 in the ad-broadcasting terminal 6 accepts the request and makes confirmation by consulting the broadcast results table 511, and transmits the confirmation results to the advertiser terminal 4 (#245). Based on the confirmation results, the discounting module 44 in the advertiser terminal 4 determines whether or not to grant a discount, and if the information is authentic, executes a discount (#246). Specifically, the discounting module 44 searches the discount table 43 with the broadcast user ID as a key, and applies to the access-permitted terminal the Discount Rate 2 from the applicable record.

Giving advertiser discounts on merchandise to a broadcast user gets the user to permit ad broadcasts for products he himself wants to buy. Accordingly, the given user's accessing users may obtain information in which the given user is interested, letting advertising be taken in naturally.

### SCREEN EXAMPLES

Next, screen instances put forth by the foregoing embodiment example will be explained giving specific examples.

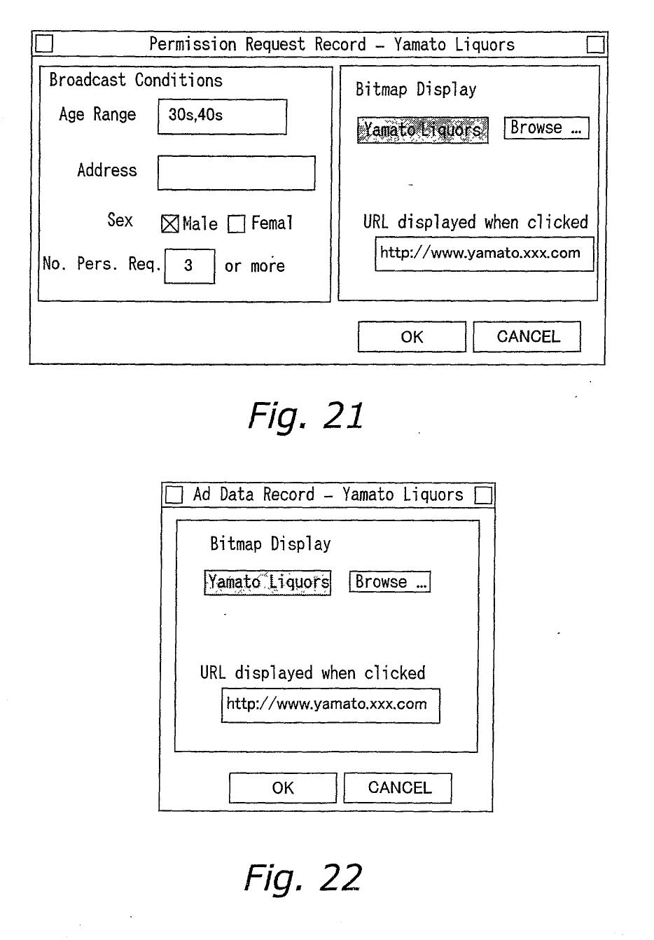

FIG. 21 is an example of an advertising-request registration screen displayed by the advertiser terminal 4. This screen is displayed by the ad-data recording module 41 in the advertiser terminal 4. The screen accepts registration of advertising information such as broadcast conditions and ad data. The embodiment may be such that not only image files, but also audio files and moving picture data can be recorded as ad data.

FIG. 22 is an example of an ad-data updating screen displayed by the advertiser terminal 4. This screen is displayed by the ad-data updating module 42. The screen accepts changes to ad data. The embodiment may also enable accepting not only ad data, but also other advertising information, e.g. changes to broadcast conditions.

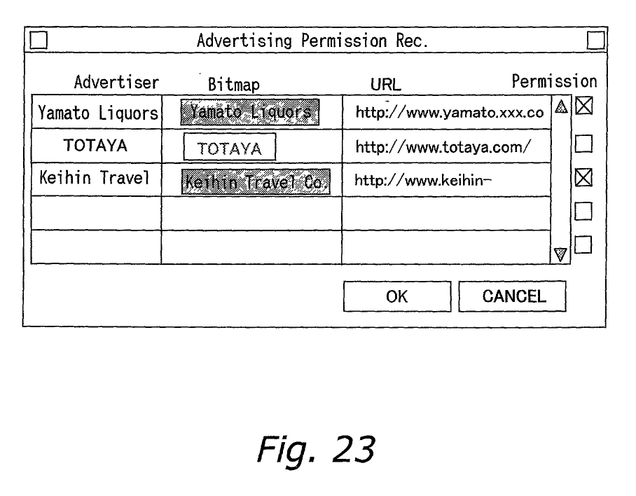

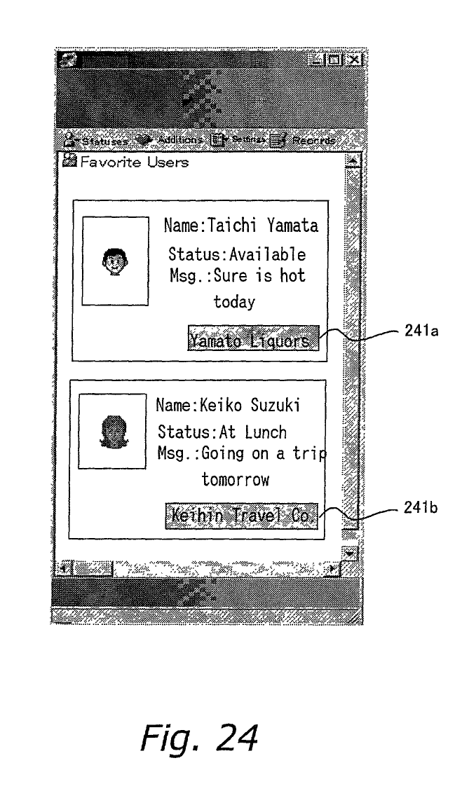

FIG. 23 is an example of a status-change permission screen display by the user terminals 2. This screen is displayed by the status-change permission module 22. Advertiser names, image files that are ad data, and their URLs, are displayed as an advertiser list on this screen. The user, by marking with permission flags the advertisers whom he permits to change his status grants own-status change permission. Conversely, if the user deletes a permission-flag mark, the user's ID is stored as a Broadcast-Suspend User in the advertising information for the relevant advertiser.

FIG. 24 is a display example of status information displayed on the user terminals 2, set out in the first embodiment example and the second embodiment example. This figure depicts a display example put forth on an access-permitted terminal for broadcast user “Taichi Yamata.” Status information “available” and “Sure is hot today” for broadcast user “Taichi Yamata” is displayed together with image data that is ad data 241a, 241b.

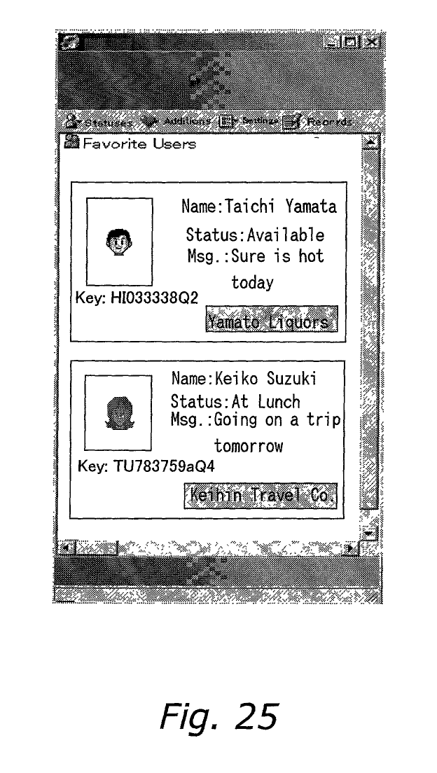

FIG. 25 is a display example of status information, displayed on the user terminals 2, set out in the third embodiment example. In this instance, in addition to the image data, generated keys are displayed together with the broadcast users' status information.

### OTHER EMBODIMENTS EXAMPLES

(A) In the foregoing embodiment examples, each user terminal grants status change permission to only a single advertiser, Nevertheless, granting status change permission to a plurality of advertisers is possible.

(B) Programs that execute the above-described method, as well as computer-readable recording media on which the programs are recorded are included in the present invention. As recording media in this respect, flexible disks, hard disks, semiconductor memory, CD-ROMs, DVDs, magneto-optical disks (MOs) and other computer-read/writeable recording media may be cited.

User status is broadcast as advertisement by utilizing the present invention, and therefore high advertising effectiveness can be expected.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. An advertising broadcast-distribution method, including:
a connecting step of connecting to a status-reporting device that broadcasts user-terminal status information;
a permission step of accepting designation of a user identifier identifying a user terminal, and designation of an advertiser identifier identifying an advertiser permitted to change information on the user terminal's status;
an advertising-storing step of storing advertising information containing, in a single record, the advertiser's name, an advertiser identifier for the advertiser, advertising data by the advertiser, and the user identifier for the user terminal, being a broadcast-user terminal, that has granted change-permission to the advertiser; and
a broadcast request step of having the status-reporting device execute broadcast of the advertising data to access-permitted terminals being user terminals that may access information on the broadcast-user terminal's status.

2. The advertising broadcast method set forth in claim 1, further including an advertising-recording step of accepting registration of the advertising data.

3. The advertising broadcast method set forth in claim 1, further including:
an advertising update step of accepting an update for the advertising data; wherein
said broadcast request step has the status-reporting device execute broadcast of the updated advertising data to the access-permitted terminals for the broadcast-user terminal for which the advertising data has been updated.

4. The advertising broadcast method set forth in claim 1, wherein said permission step and said advertising-storing step are iterated to generate a plurality of the records, and said permission step includes:
an accepting step of accepting from the user terminal a demand for a listing of advertisers stored in said advertising-storing step;
a list-transmission step of transmitting to the user terminal an advertiser list containing advertiser names stored by said advertising-storing step; and
a designation-acceptance step of accepting from the user terminal at least one designation of an advertiser contained in the advertiser list; wherein
said advertising-storing step stores the user identifier for the user terminal as the broadcast-user terminal for the advertiser designated in said designation-acceptance step.

5. The advertising broadcast method set forth in claim 1, wherein said advertising-storing step stores advertising information further containing within the single record broadcast conditions for the advertising data.

6. The advertising broadcast method set forth in claim 5, further including a user-information storing step of storing the user terminal's user identifier, and user information relating to the user terminal, as a single record;
said permission step including:
an acceptance step of accepting from the user terminal a demand for a listing of advertisers stored in said advertising-storing step;
an extraction step of extracting advertising information whose broadcast conditions are satisfied by the user terminal's user information;
a list transmission step of transmitting to the user terminal an advertiser list made up of the extracted advertising information;
a designation-acceptance step of accepting from the user terminal designation of at least one advertiser contained in the advertiser list; wherein
said advertising-storing step stores the user terminal's user identifier as a broadcast terminal for the advertiser designated in said designation-acceptance step.

7. The advertising broadcast method set forth in claim 1, further including:
a user-information recording step of recording user information containing, in a single record, the user identifier, status information on the user terminal specified by the user identifier, and access-permitted user identifiers for terminals that may access the status information;
a status update step of accepting a latest-status report on, and updating the status information for, the user terminal recorded in said user-information recording step; and
a status reporting step, if the user terminal's status information has been updated, of reporting the latest status information to the user terminal's access-permitted terminals; wherein
said broadcast request step has broadcast of the advertising data executed by said status update step and said status reporting step.

8. The advertising broadcast method set forth in claim 1, further including:
a user-information recording step of recording user information containing, in a single record, the user identifier, and conduciveness-level data indicating a conduciveness level at which the user has contributed to the broadcasting of advertising data; and
a conduciveness-level computation step of computing the conduciveness level based on the user information.

9. The advertising broadcast method set forth in claim 1, wherein:
said advertising-storing step further stores, in the single advertising-information record, an advertising fee; and
further including an advertising-fee computation step of computing the advertising fee.

10. The advertising broadcast method set forth in claim 1, further including:
a broadcast-results storing step of storing broadcast-result information indicating results of the broadcasting of the advertising data; and
broadcast-results transmission step of transmitting the broadcast-result information.

11. An advertising program for making a computer function as:
connecting means for connecting to a status-reporting device that broadcasts user-terminal status information;
permission means for accepting designation of a user identifier identifying a user terminal, and designation of an advertiser identifier identifying an advertiser permitted to change information on the user terminal's status;
advertising-storing means for storing advertising information containing, in a single record, an advertiser's name, an advertiser identifier for the advertiser, advertising data by the advertiser, and a user identifier for a broadcast-user terminal being a user terminal that has granted change-permission to the advertiser; and
broadcast request means for having the status-reporting device execute broadcast of the advertising data to access-permitted terminals being user terminals that may access information on the broadcast-user terminal's status.

12. A computer-readable recording medium on which is recorded an advertising program for executing:
a connecting step of connecting to a status-reporting device that broadcasts user-terminal status information;
a permission step of accepting designation of a user identifier identifying a user terminal, and designation of an advertiser identifier identifying an advertiser permitted to change information on the user terminal's status;
an advertising-storing step of storing advertising information containing, in a single record, an advertiser's name, an advertiser identifier for the advertiser, advertising data by the advertiser, and a user identifier for a broadcast-user terminal being a user terminal that has granted change-permission to the advertiser; and
a broadcast request step of having the status-reporting device execute broadcast of the advertising data to access-permitted terminals being user terminals that may access information on the broadcast-user terminal's status.

13. An advertising broadcast-distribution device furnished with:
connecting means for connecting to a status-reporting device that broadcasts user-terminal status information;
permission means for accepting designation of a user identifier identifying a user terminal, and designation of an advertiser identifier identifying an advertiser permitted to change information on the user terminal's status;
advertising-storing means for storing advertising information containing, in a single record, an advertiser's name, an advertiser identifier for the advertiser, advertising data by the advertiser, and a user identifier for a broadcast-user terminal being a user terminal that has granted change-permission to the advertiser; and
broadcast request means for having the status-reporting device execute broadcast of the advertising data to access-permitted terminals being user terminals that may access information on the broadcast-user terminal's status.

14. An advertising request method including:
a connecting step of connecting via a network to an advertising-broadcast device that executes the advertising broadcast-distribution method set forth in said claim 1;
a recording step of accepting registration of advertising information on an advertiser;
a request step of transmitting the advertising information and an advertising request to the advertising-broadcast device;
an update step of accepting an update for the advertising information; and
an update request step of transmitting updated advertising information to the advertising-broadcast device via the network.

15. The advertising request method set forth in claim 14, further including:
a privileges storing step of storing privileges content offered to a broadcast-user terminal being a user terminal that has permitted status-information changes by the advertiser, of storing a user identifier identifying the broadcast-user terminal, and of storing combinations of the two; and
a privileges update step of receiving from the advertising-broadcast device broadcast-result information indicating results of broadcasting the advertising information, and based on the broadcast-result information updating the privileges content

16. An advertising permission computer product for making a computer, having a status-reporting client, function on a status-reporting system, the advertising permission computer product for making the computer function as:
status reporting means for reporting user status information, identifiers for access-permitted terminals being computers that may access the own status information, and/or identifiers for access-desiring terminals being computers that would like to access the status information;
connection means for connecting via a network with an advertising-broadcast device that executes the method set forth in claim 1; and
permission reporting means for reporting to the advertising-broadcast device advertisers who are permitted to change the self-status information.

17. A computer-readable recording medium on which is recorded an advertising permission program utilized in a computer having a status-reporting client on a status-reporting system, the computer-readable recording medium on which is recorded the advertising permission program for executing:
a status reporting step of reporting user status information, identifiers for access-permitted terminals being computers that may access the own status information, and/or identifiers for access-desiring terminals being computers that would like to access the status information;
a connection step of connecting via a network with an advertising-broadcast device that executes the method set forth in claim 1; and
a permission reporting step of reporting to the advertising-broadcast device advertisers who are permitted to change the self-status information.
